(19) United States
(12) Patent Application Publication
(10) Pub. No.: US 2005/0219223 A1
(43) Pub. Date: Oct. 6, 2005

(54) Method and apparatus for determining the context of a device

(76) Inventors: Michael D. Kotzin, Buffalo Grove, IL (US); Rachid Alameh, Crystal Lake, IL (US)

Correspondence Address: MOTOROLA INC, 600 NORTH US HIGHWAY 45, ROOM AS437, LIBERTYVILLE, IL, 60048-5343, US

(21) Appl. No.: 10/814,370

(22) Filed: Mar. 31, 2004

(51) Int. Cl. G09G 5/00

(52) U.S. Cl. 345/173

(57) ABSTRACT

A handheld electronic device (100) includes at least one context sensing circuit and a microprocessor (204), and a user interface (212). The sensing circuit detects (205) either a contextual characteristic of the device (e.g., ambient light, motion of the device or proximity to or contact another object) or how the user is holding the device and generates a virtual output (207) representative of the sensed characteristic. The sensed contextual characteristic is associated with a data management function of the device and a virtual physical representation to be output in response to the execution of the data management function is determined. The virtual physical representation is related to the sensed contextual characteristic or the data management function. The virtual physical representation is output by a user interface of the device.

### FIELD OF THE INVENTION

The present invention relates generally to content management, and more particularly to content management based on a device context.

### BACKGROUND OF THE INVENTION

Data management within a single device and between multiple electronic devices is generally transparent to the device user. Data is typically managed through representations and the use of a user interface. A user interface presents to the user a representation of the data management, characteristic or processes such as the moving of data, the execution of programs, transferring data and the like as well as a way for the user to provide instructions or input. The current methods employed to represent the data management or movement however do not allow the user to easily or interactively associate with the data management task being performed. Users in general have a difficult time dealing with or associating with content. This problem is particularly troublesome with licensed content such as digitized music wherein the user who licensed and downloaded the content does not physically see the bits and bytes which make up the particular content. Therefore, managing this type of information is less intuitive to the user.

The methods employed in the actual physical management of the data within and between electronic devices are generally known. Data is managed within a device by a controller or microprocessor and software which interacts therewith. The user interacts with the software to direct the controller how to manage the data. For example, data may be transferred from one device to another device manually by the user or automatically in response to commands in a application. In either case, the data may be transferred via wires and cables, or wirelessly wherein the actual transfer process is generally transparent to the user. Graphical representations are one example of software generated depictions of the transfer process or the progress which are displayed on the user interface to allow the user to visually track the operation being performed. One example is the presentation of a “progress bar” on the device's display, which represents the amount of data transferred or the temporal characteristics related to the data transfer. These current methods of data management representations are non-interactive however and do not allow the user to associate or interact with the actual management of data. This results in a greater difficulty in device operation.

What is needed is a method and apparatus that allows a user to associate and interact with the management of data in an intuitive manner that is related to the context of the device thereby improving the ease of use.

### BRIEF DESCRIPTION OF THE DRAWINGS

The various aspects, features and advantages of the present invention will become more fully apparent to those having ordinary skill in the art upon careful consideration of the following Detailed Description of the Drawings with the accompanying drawings described below.

FIG. 1 illustrates an exemplary electronic device.

FIG. 2 illustrates an exemplary circuit schematic in block diagram form of a wireless communication device.

FIG. 3 illustrates an exemplary flow diagram of a data management process.

FIG. 4 Illustrates an exemplary flow diagram of a data management process.

FIG. 5 illustrates an exemplary electronic device.

FIG. 6 is an exemplary cross section of a touch sensor.

FIG. 7 illustrates an exemplary touch sensor circuit diagram.

FIG. 8 is an exemplary back side of the electronic device.

FIG. 9 illustrates an exemplary flow diagram of a data management process.

### DETAILED DESCRIPTION OF THE DRAWINGS

While the present invention is achievable by various forms of embodiment, there is shown in the drawings and described hereinafter present exemplary embodiments with the understanding that the present disclosure is to be considered an exemplification of the invention and is not intended to limit the invention to the specific embodiments contained herein.

A method and apparatus for interactively managing information in a device in response to contextual input is disclosed. An electronic device has information, commonly referred to as data or content, which is stored therein. Content management includes controlling the device, controlling or managing data within the device or transferring information to another device. Sensors carried on the device, internally or externally, sense environmental or contextual characteristics of the device in relation to other objects or the user. In response to the sensed environmental characteristic, an operation or function is performed with regard to the content or operation of the device. The contextual characteristics may be static or dynamic. A user interface carried on the device provides feedback to the user which corresponds to the sensed environmental or contextual characteristic. The feedback may be in the form of virtual physical feedback. Virtual physical feedback is a presentation of information that generally illustrates common physical properties which are generally understood. The virtual physical representation is information which a user can easily relate to as following basic physical science principles and are commonly understood by the user. In addition, the device may perform one function in response to an environmental characteristic while the device is in a first mode, and the device may perform a second function in response to the same environmental characteristic while the device is in a second mode.

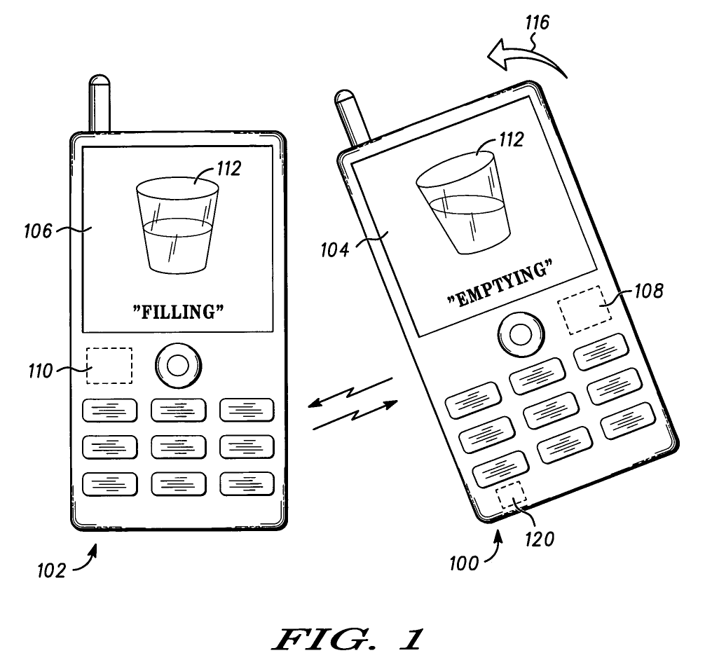

In FIG. 1, one exemplary embodiment of a first electronic device 100 is shown sensing a contextual characteristic and presenting to the user a virtual physical representation of the sensed characteristic. In this embodiment, the sensed contextual characteristic corresponds to the function of transferring data from one device to another. Upon sensing the contextual characteristic, the first device 100 executes a data management function, which in this exemplary embodiment is the transfer of the desired data to a second electronic device 102. In this embodiment, the first device 100 has a first display 104 and the second device 102 as a second display 106. The first device 100 also has a transmitter 108 that wirelessly transmits data to a receiver 110 in the second device 102. Although the transmission in the exemplary embodiment of FIG. 1 is wireless, the data may be transferred through a wired connection as well.

In the exemplary embodiment of FIG. 1, the sensed contextual characteristic is the “pouring” gesture made with the first device 100. The first display 104 is shown depicting a glass full of water 112, wherein the water is representative of the content to be transferred. As the first device 100 senses the contextual characteristic of tilting 114, (i.e. pouring) indicated by arrow 116, as if to pour the content into the second device 102, the liquid in the glass shown on the first display 104 begins to empty, as if it were being poured in response to the pouring gesture of the first device 100 moving in a pouring like manner. This interactive data management allows the user to associate with the actual transfer of the content with an understandable physical property. The simulation of the virtual water pouring from the glass corresponds directly to the transferring of the content from the first device 100 to the second device 102.

The context characteristic sensor 120 senses the pouring gesture of the first device 100 and in this exemplary executes the data management function (i.e. the data transfer to the second device) and the display of the water emptying from the glass. The sensed context characteristic may also initiate the link negotiation or establishment between the first device 100 and the second device 102 as well. As the electronic device 100 is tipped more the virtual glass empties more and faster. The data may or may not exchange between the devices at different rates as the acceleration of change in pouring angle changes. In one the exemplary embodiment, the data transfers at the highest possible rate. However the user may control the amount of data transferred. In this exemplary embodiment, if the user stops tipping the device, the data transfer will terminate or suspend along with the virtual glass of water. If the all of the data has already been transferred, an apportionment control message may be transmitted to the second device to instruct the second device to truncate the data to the desired amount indicated by a contextual characteristic command.

If the second device 102 has the same or similar capability, the second device may display on the second display 106, a glass filling up with water as the data is transferred. The graphical representation of the virtual physical representation however does not have to be the same from first device 100 (sending device) to the second device (receiving). The user of the second device 102 may select a different graphical representation desired to be displayed during a data transfer. In one embodiment the second device 102 does not have the same animation or virtual physical representation as the first device 100 stored therein, and the first device 100 may transfer the animation so that there is a complimentary pair of animation graphics. Users may choose or custom create virtual physical representations to assign to different functions such as receiving data in this embodiment. The pouring of content from the first device to the second device is one exemplary embodiment of the present invention. Relating the context of the device 100 to an operation and presenting that operation in a virtual physical form can take the form of numerous operations and representations thereof as one skilled in the art would understand. Other various exemplary embodiments are disclosed below but this is not an exhaustive list and is only meant as exemplary in explaining the present invention.

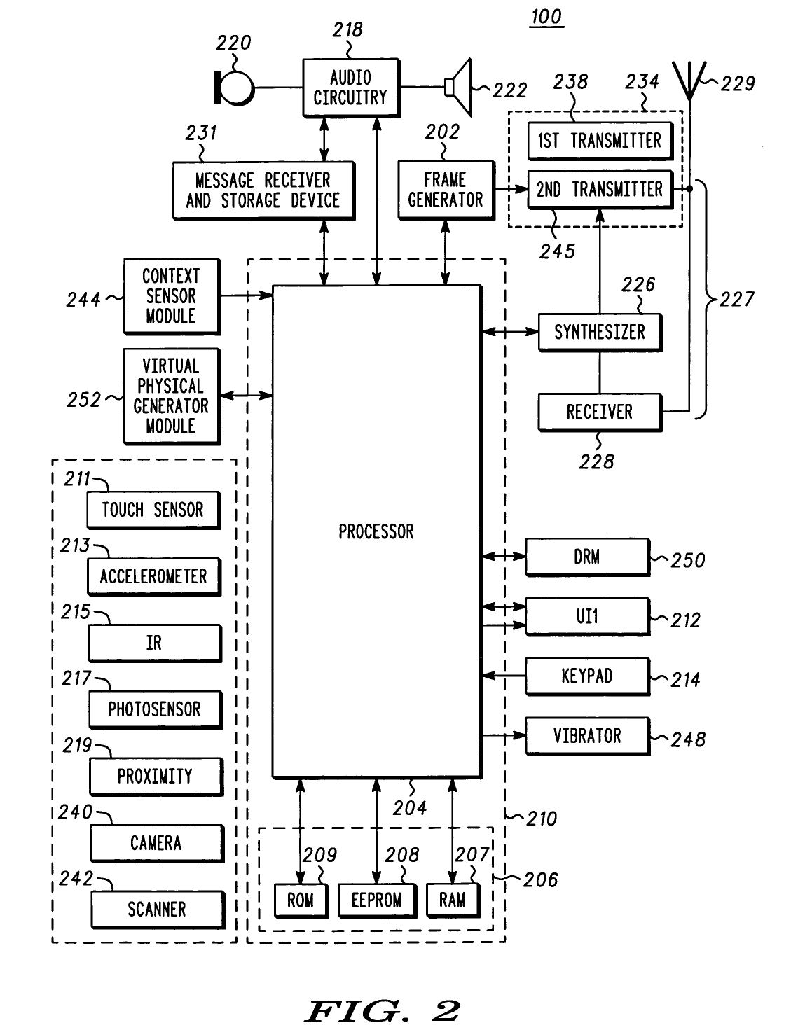

Turning to FIG. 2, an exemplary electronic device 200 is shown in block diagram from in accordance with the invention. This exemplary embodiment is a cellular radiotelephone incorporating the present invention. However, it is to be understood that the present invention is not limited to a radiotelephone and may be utilized by other electronic devices including gaming device, electronic organizers, wireless communication devices such as paging devices, personal digital assistants, portable computing devices, and the like, having wireless communication capabilities. In the exemplary embodiment a frame generator Application Specific Integrated Circuit (ASIC) 202, such as a CMOS ASIC and a microprocessor 204, combine to generate the necessary communication protocol for operating in a cellular system. The microprocessor 204 uses memory 206 comprising RAM 207, EEPROM 208, and ROM 209, preferably consolidated in one package 210, to execute the steps necessary to generate the protocol and to perform other functions for the wireless communication device, such as writing to a display 212 or accepting information from a keypad 214. Information such as content may be stored in the memory 206 or it may be stored in a subscriber identity module (SIM) 390 or other removable memory such as compact flash card, secure digital (SD) card, SmartMedia, memory stick, USB flash drive, PCMCIA or the like. The display 212 can be a liquid crystal display (LCD), a light emitting diode (LED) display, a plasma display, or any other means for displaying information. ASIC 202 processes audio transformed by audio circuitry 218 from a microphone 220 and to a speaker 222.

A context sensor 224 is coupled to microprocessor 204. The context sensor 224 may be a single sensor or a plurality of sensors. In this exemplary embodiment, a touch sensor 211, accelerometer 213, infrared (IR) sensor 215, photo sensor 217 make up together or in any combination the context sensor 224; all of which are all coupled to the microprocessor 204. Other context sensors, such as a camera 240, scanner 242, and microphone 220 and the like may be used as well as the above list is not an exhaustive but exemplary list. The first device 100 may also have a vibrator 248 to provide haptic feedback to the user, or a heat generator (not shown), both of which are coupled to the microprocessor 204 directly or though an I/O driver (not shown).

The contextual sensor 224 is for sensing an environmental or contextual characteristic associated with the device 100 and sending the appropriate signals to the microprocessor 204. The microprocessor 204 takes all the input signals from each individual sensor and executes an algorithm which determines a device context depending on the combination of input signals and input signal levels. A context sensor module 244 may also perform the same function and may be coupled to the microprocessor 204 or embedded within the microprocessor 204. Optionally a proximity sensor senses the proximity of a second wireless communication device. The sensor may sense actual contact with another object or a second wireless communication device or at least close proximity therewith.

FIG. 2 also shows the optional transceiver 227 comprising receiver circuitry 228 that is capable of receiving RF signals from at least one bandwidth and optionally more bandwidths, as is required for operation of a multiple mode communication device. The receiver 228 may comprise a first receiver and a second receiver, or one receiver capable of receiving in two or more bandwidths. The receiver depending on the mode of operation may be attuned to receive AMPS, GSM, CDMA, UMTS, WCDMA, Bluetooth, WLAN, such as 802.11 communication signals for example. Optionally one of the receivers may be capable of very low power transmissions for the transmission of link establishment data transfer to wireless local area networks. Transmitter circuitry 234, is capable of transmitting RF signals in at least one bandwidth in accordance with the operation modes described above. The transmitter may also include a first transmitter 238 and second transmitter 240 to transmit on two different bandwidths or one transmitter that is capable of transmitting on at least two bands. The first bandwidth or set of bandwidths is for communication with a communication system such as a cellular service provider. The second bandwidth or set of bandwidths is for point-to-point communication between two devices or a device and a WLAN.

A housing 242 holds the transceiver 227 made up of the receiver 228 and the transmitter circuitry 234, the microprocessor 204, the contextual sensor 224, and the memory 206. In memory 206 an optional ad hoc networking algorithm 244 and a database 246 are stored. The sensor 224 is coupled to the microprocessor 204 and upon sensing a second wireless communication device causes microprocessor 204 to execute the ad hoc link establishment algorithm 244.

Still further in FIG. 2, a digital content management module 250, also known as a DRM agent, is coupled to the microprocessor 204, or as software stored in the memory and executable by the microprocessor 204.

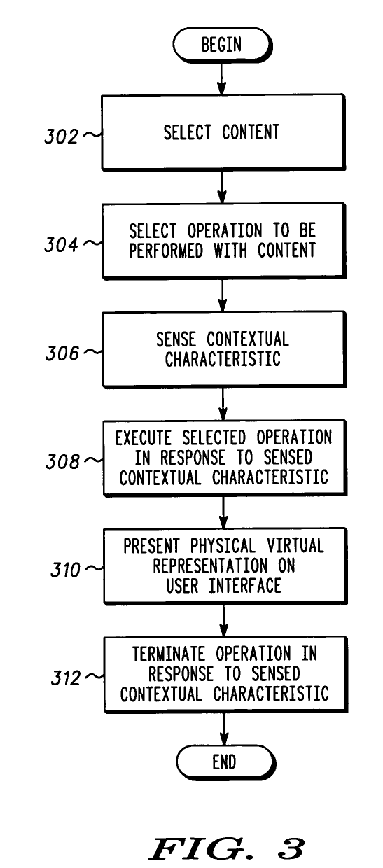

Turning to FIG. 3, an exemplary flow diagram illustrates the steps of sensing the contextual characteristics of the first device 100 and presenting the virtual physical output, in accordance with the present invention. The content to be transferred from the first device 100 to the second device 102 is selected 302. The operation to be performed on the content is then selected 304. The first device 100 senses 306 the context of the first device 100 through the context sensor 120. In response to the sensed contextual characteristic, the selected operation is initiated 308. Presentation of the virtual physical representation is output through a user interface of the first device 100, the display 104 in this exemplary embodiment.

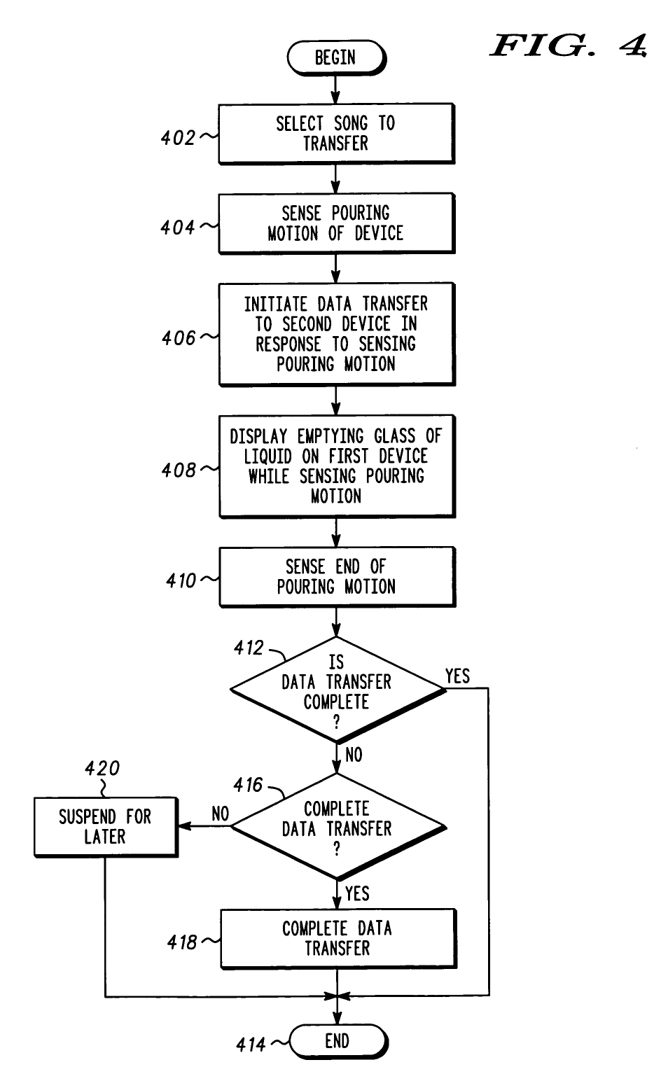

More particular, FIG. 4 shows an exemplary flow diagram, in accordance with FIG. 1, and the present invention. First a song is selected 402 to be transferred to the second device 102. The first device 100 then senses 404 the pouring gesture or motion of the first device 100. Optionally, the user may select the context to be sensed. A plurality of context characteristic may be available for selection by the user to manage the content. The first device 100 may also automatically sense the contextual characteristic of the first device 100. In response to sensing the pouring gesture as shown in FIG. 1, the first device 100 initiates 406 a data transfer of the song selected 402 to the second device 102. Also in response to sensing the pouring gesture, the first device 100 presents 408 on the display 104 a virtual physical representation of a glass pouring liquid. The first electronic device 100 then senses 410 termination of the pouring gesture. The first electronic device 100 determines 412 if the data transfer to the second device 102 is complete. If the data transmission is complete, the virtual physical representation of the glass will show an empty glass and the link to the second device 102 is terminated 414. If the data transmission is not complete, the virtual physical representation of the glass will show an amount of water left in the glass that proportional to the amount of data remaining to be transferred. At this point the first device 100 may determine 416 if the user wishes to complete 418 the data transfer or suspend 420 the data transfer. If the user desires to suspend 420 the data transfer, the data transferred to the second device 102 may be a partial transfer or the data transfer may be resumed at a later time. In this exemplary embodiment, the user may use the pouring gesture with the first device 100 to control the amount of data received by the second device 102. The user would “pour” the content until the amount of content received by the second device 102 is the desired amount. The user stops the pouring gesture to terminate the data transfer whether or not the data transfer is complete.

The contextual characteristic sensor 120 may be a single sensor or a system of sensors. The system of sensors may be sensors of the same or different types of sensors. For example the environmental characteristic sensor 120 of the first device 100 may be a single motion sensor such as an accelerometer. For the embodiment illustrated in FIG. 1 and FIG. 4, an accelerometer or multiple accelerometers may be carried on the device to sense the pouring gesture of the first device 100. As those skilled in the art understand, other forms of motion and position detection may be used to sense the position of the device relative to its environment. Alternatively multiple types of sensors may be used to ensure the desired context is sensed in a repeatable manner. For example, the first device 100 may be tipped as with the pouring gesture however the intent of the user was not to transfer data. Other contextual sensors may be used in combination with the motion sensor, for example, to verify or validate a sensed contextual characteristic as discussed below.

Another sensor the first device 100 may carry is a proximity sensor which senses the proximity of the first device 100 to a second device. As the first device 100 comes within close proximity to the second device 102, the data transfer would be initiated and in this exemplary embodiment the virtual physical representation would be presented on the user interface. In order to ensure that the first device is contacting a second device 102 with the capability to transfer or accept data directly form the device, the proximity sensor would have identification capability. The second device 102 transmits a code identifying the second device 102, the second device capabilities, or a combination thereof. The second device may also transmit radio frequency information which may then be used by the first device 100 to establish a communication link with the second device 102.

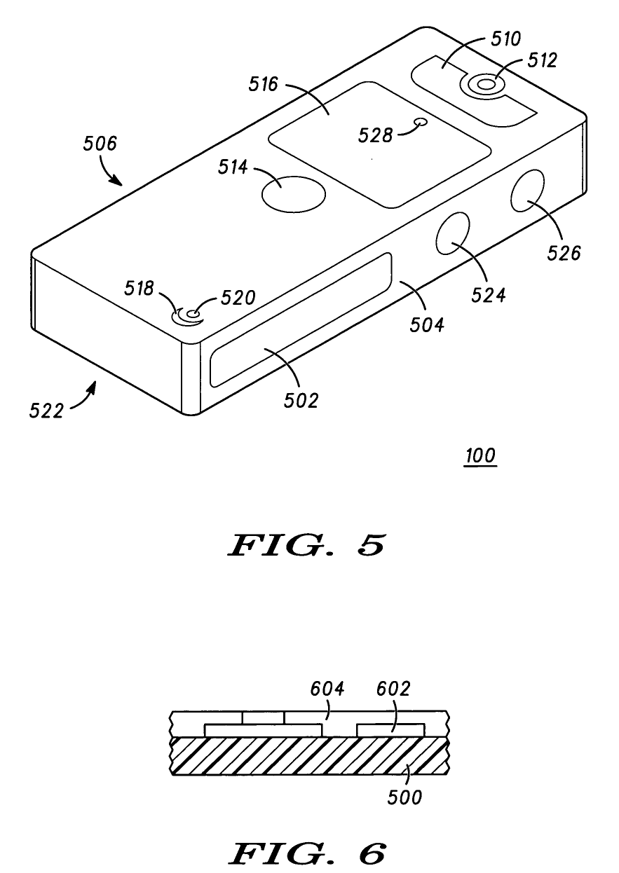

In yet another embodiment, the first device 100 may carry a touch sensor (FIG. 5). The touch sensor is activatable from the exterior of the housing 500 so that contact or close proximity by a foreign object, such as the user, activates the touch sensor. Activation of the touch sensor by the user or an object would initiate the desired data management operation. The first device 100 may have a plurality of touch sensors carried at multiple independent locations on the housing 500 of the first device 100. The locations may correspond to different sides of the device or to different user interfaces or portions thereof. The location of the touch sensors relative to the housing may also match points of contact by objects such as user's fingers and other parts of the body when the first device 100 is held in predetermined positions. The touch sensors then determine when the first device 100 is held in a certain common manner and that touch information determined by the device 100.

FIG. 5 illustrates an exemplary electronic device, such as the first device 100, having a plurality of touch sensors carried on the housing 500. The housing 500 in this exemplary embodiment is adapted to be a handheld device and griped comfortably by the user. A first touch sensor 502 of the plurality of touch sensors is carried on a first side 504 of the device 100. A second touch sensor 506 (not shown) is carried on a second side 508 of the housing 500. A third touch sensor 510 is carried on the housing 500 adjacent to a speaker 512. A fourth touch sensor 514 is carried on the housing 500 adjacent to a display 516. A fifth touch sensor 518 is carried adjacent to a microphone 520. A sixth touch sensor 522 is on the back of the housing (not shown). A seventh 524 and eighth 526 touch sensor are also on the first side 504. In the exemplary embodiment, the seventh 524 and eighth 526 touch sensors may control speaker volume or may be used to control movement of information displayed on the display 516.

The configuration or relative location of the eight touch sensors on the housing 500 that are included in the overall device context sensor allow the microprocessor 204 to determine for example how the housing 500 is held by the user or whether the housing 500 is placed on a surface in a particular manner. When the housing 500 is held by the user, a subset of touch sensors of the plurality of touch sensors are activated by contact with the users hand while the remainder are not. The particular subset of touch sensros that is activated correlates to the manner in which the user has gripped the housing 500. For example, if the user is gripping the device as to make a telephone call, i.e. making contact with a subset of touch sensors) the first touch sensor 502 and the second touch sensor 506 will be activated in addition to the sixth touch sensor 522 on the back of the housing 500. The remaining touch sensors will not be active. Therefore, signals from three out-of-eight touch sensors is received, and in combination with each sensors known relative position, the software in the device 100 correlates the information to a predetermined grip. In particular, this touch sensor subset activation pattern will indicate that the user is holding the device in a phone mode with the display 516 facing the user.

In another exemplary embodiment, one touch sensor is electrically associated with a user interface adjacent thereto. For example the third touch sensor 510 which is adjacent to the speaker 512 is operative to control the speaker. Touching the area adjacent to the speaker toggles the speaker on or off. This provides intuitive interactive control and management of the electronic device operation.

The touch sensor in the exemplary embodiment is carried on the outside of the housing 500. A cross section illustrating the housing 500 and the touch sensor is shown in FIG. 6. The contact or touch sensor comprises conductive material 602 placed adjacent to the housing 500. It is not necessary that the conductive material be on the outside portion of the housing as shown in FIG. 6 as long as long as a capacitive circuit can be formed with an adjacent foreign object. The conductive material 602 may be selectively placed on the housing 500 in one or more locations. In this exemplary embodiment, carbon is deposited on the housing 500 and the housing 500 is made of plastic. The carbon may be conductive or semi-conductive. The size of the conductive material 602 or carbon deposit is dependant on the desired contact area to be effected by the touch sensor. For example, a touch sensor that is design to sense the grip of a user's hand on the housing may be larger, i.e. have more surface area than a touch sensor designed to be used as a volume control. To protect the conductive material 602, a protective layer 604 is adjacent to the conductive material 602 layer. In this exemplary embodiment, the protective layer 604 is a paint coating applied over the conductive material 602. In this embodiment, a non-conductive paint is used to cover the carbon conductive material 602. Indicia may be applied to the paint indicating where the touch sensor is located as this may not be determined with the painted surface.

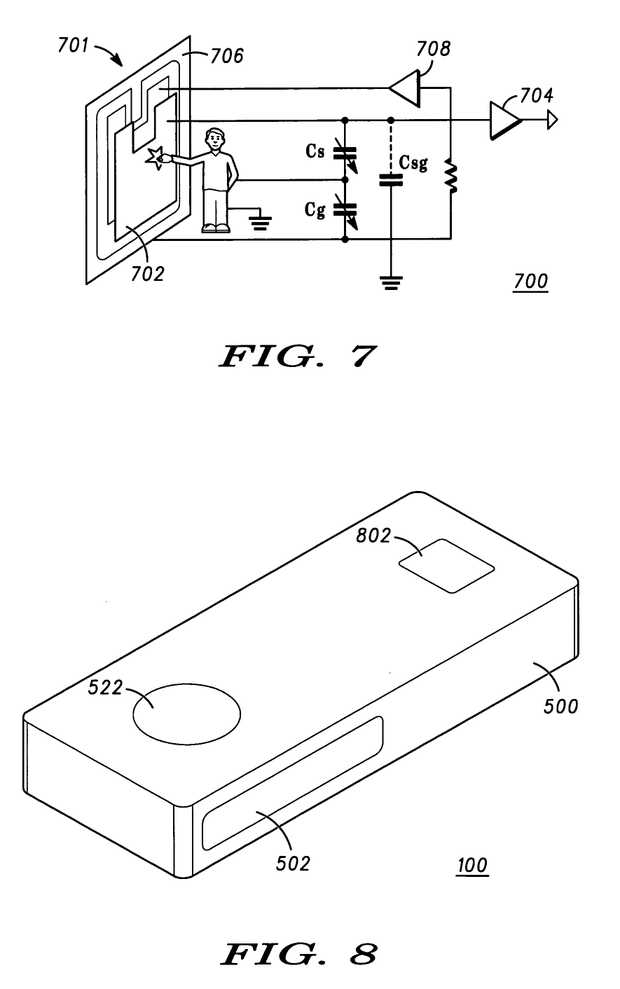

Moving to FIG. 7, an exemplary touch sensor circuit 700 is shown. In this exemplary embodiment a capacitance controlled oscillator circuit is used to sense contact with the touch sensor 701. The circuit 700 operates at a predetermined frequency when there is zero contact with the touch sensor 701. The circuit frequency lowers as a result of contact (or substantially adjacent proximity) made with the touch sensor 701. The touch sensor 701 comprises a sensor plate 702 made of the conductive material 602. The sensor plate 702 is coupled to a first op amp 704 such that the circuit 700 operates at the reference frequency which in this exemplary embodiment is 200 kHz. In the exemplary touch sensor circuit 700 a ground plate 706 is placed adjacent to the sensor plate 702. The ground plate 706 is insulated from the sensor plate 702. The ground plate 706 is coupled to a second op amp 708 which is coupled to a battery ground. The oscillator frequency is affected by the capacitance between the sensor plate and an object placed adjacent to the sensor plate 702. The oscillator frequency is inversely proportional to the capacitance value created by contact with the touch sensor. The greater the capacitance created by contact with the sensor plate 702, the greater the change in the oscillator frequency. Therefore, as the capacitance increases the oscillator circuit frequency approaches zero. The change in frequency, i.e. drop from 200 kHz, indicates that there is an object adjacent to the sensor plate and hence adjacent to the housing 500. The capacitance is a function of the size of the sensor plate 702 and the percent of the sensor plate 702 in contact with the object. As a result, the circuit frequency varies with the amount of coverage or contact with the sensor plate 702. Different frequencies of the circuit may therefore be assigned to different functions of the device 100. For example, touching a small portion of a touch sensor may increase the speaker volume to 50% volume and touching substantially all of the touch sensor may increase the speaker volume to 100% volume.

Turing back to FIG. 5, the exemplary housing 500 optionally includes an infrared (IR) sensor. In this exemplary embodiment, the IR sensor 528 is located on the housing 500 adjacent to the display 516, but may be located at other locations on the housing 500 as one skilled in the art will recognize. In this exemplary embodiment, the IR sensor 528 may sense proximity to other objects such as the user's body. In particular the IR sensor may sense how close the device 100 is to the users face for example. When the IR sensor 528 senses that the housing 500 is adjacent to an object, (i.e. the user's face) the device 100 may reduce the volume of the speaker to an appropriate level.

In another embodiment, the output from the IR sensor 528 and the output from the plurality of touch sensors are used to determine the contextual environment of the device 100. For example, as discussed above, the volume may be controlled by the sensed proximity of the objects and in particular the users face. To ensure that the desired operation is carried out at the appropriate time (i.e. reducing the volume of the speaker in this exemplary embodiment) additional contextual information may be used. For example, using the touch sensors 502, 506, 510, 514, 518, 524 and 526 which are carried on the housing 500, the device may determine when the housing is being gripped by the user in a manner that would coincide with holding the housing 500 adjacent to the users face. Therefore a combination of input signals sent to the microprocessor 204; one, or one set, from the subset of touch sensors and a signal from the IR sensor 528 representing the close proximity of on object (i.e. the users head) will be required to change the speaker volume. The result of sensing the close proximity of an object may also depend on the mode the device 100 is in. For example, if the device 100 is a radiotelephone, but not in a call, the volume would not be changed as a result of the sensed contextual characteristic.

Similarly, a light sensor, as illustrated in FIG. 8, may be carried on the housing 500. In this exemplary embodiment, the light sensor 802 senses the level of ambient light present. In this exemplary embodiment, when the device 100 is placed on the back housing, on a table for example, zero or little light will reach the light sensor 902. In this configuration, the sixth touch sensor 522 will also be activated if present on the device 100. The combination of the zero light reading and the activated sixth touch sensor 522 indicates to the device 100, through an algorithm and the microprocessor 204, that the device is on its back side. One skilled in the art will understand that this, and the combinations discussed above can indicate other configurations and contextual circumstances. The predetermined settings will determine which outcome or output function is desired as a result of the particular activated sensor combination. In general, the outcome or desired function which is most common with the context sensed by the device 100 contextual sensors will be programmed and result as a output response to the sensed input.

Similar to the example discussed above concerning context changes resulting in the change in speaker volume, when the light sensor 802 reads substantially zero, the device 100 is assumed to be placed on its back in one exemplary embodiment such as on a table for example. In this exemplary embodiment, the device 100 would automatically configure to speakerphone mode and the volume adjusted accordingly. Another contextual characteristic would result from the light sensor sensing substantially zero light and the IR sensor sensing the close proximity of an object. This may indicate that the device 100 is covered on both the front and back such as in the user's shirt pocket. When this contextual characteristic is sensed the device changes to vibrate mode.

Other contextual sensors may be a microphone, a global positioning system receiver, temperature sensors or the like. The microphone may sense ambient noise to determine the device's environment. The ambient noise in combination with any of the other contextual characteristic sensors may be used to determine the device's context. As GPS technology is reduced in size and economically feasible, the technology is implemented into more and more electronic devices. Having GPS reception capability provides location and motion information as another contextual characteristic. The temperature of the device 100 may also be considered as a contextual characteristic either alone or in combination with any of the other contextual sensors of the device 100.

The virtual physical representation which relates the contextual characteristic of the device may be a representation that the user will understand and associate with the nature of the contextual characteristic. As discussed above, the representation of the glass emptying in relation to the pouring gesture made with the housing 500. The pouring of liquid from a glass is a common occurrence that is easily understandable by the user.

The gesture of pouring a liquid from a glass as discussed above is one example of a contextual characteristic which is sensed by the device 100. Other contextual characteristics sensed by any combination of contextual sensors including those listed above, include the manner in which the device 100 held, the relation of the device 10 to other objects, the motion of the device including velocity, acceleration, temperature, mode, ambient light, received signal strength, transmission power, battery charge level, the number of base stations in range of the device, the number of internet access points as well as any other context related characteristics related to the device.

In one exemplary embodiment, the virtual physical representation may be the graphical representation of a plunger on the display of the first device 100. The plunger motion or animation would coincide with a contextual characteristic of a push-pull motion of the housing 100. For example, the user may want to “push” data over to a second device or to a network. The user would physically gesture with the device 100 a pushing motion and the display on the device 100 would show the virtual physical representation of a plunger pushing data across the display. In one embodiment, wherein the data is being transferred to a second device, and wherein the second device 102 has a display, as the data is transferred the second device display 106 would also show the virtual physical representation of the data being plungered across the display. In one embodiment, a similar representation of a syringe is displayed as a form of a plunger and the operation of which is also well understood by people. In one embodiment incorporating a virtual representation of a syringe, may further include a physical plunger movably coupled to the device 100. The physical plunger would reciprocate relative to the device. The reciprocating motion of the physical plunger would be sensed by motion sensors as a contextual characteristic of the device 100. A function, such as the transfer of data would result from the reciprocating motion and the virtual plunger or syringe may also be presented on the user interface. It is understood that various paradigms exploiting the concept of physical movement may benefit from the incorporation of virtual physical representations of actual physical devices such as plungers and syringes. It is also understood that other physical devices may be incorporated as virtual physical devices and the present invention is not limited to the exemplary embodiments given.

In another embodiment, the motion of shaking the housing 500 is used to manage the data. In one example, when the shaking motion is sensed, the data is transferred to the second device 102. In another example, the shaking gesture performs a function such as organizing the “desktop” or deleting the current active file. The shaking motion may be sensed by accelerometers or other motion detecting sensors carried on the device.

In yet another exemplary embodiment, a specific motion or motion pattern of the first device 100 is captured and may be stored. The motion is associated with the content which is to be transferred and in one embodiment is captured by accelerometers carried on the first device 100. Electrical signals are transmitted by the accelerometers to the microprocessor 204 and are saved as motion data, motion pattern data or a motion “fingerprint” and are a representation of the motion of the device. The motion data is then transmitted to a content provider. The second device 102, is used to repeat the motion, and accelerometers in the second device 102 save the motion data and transmit the motion data to the content provider. The content provider matches the motion data and sends the content to the second device 102. In other words it is possible that the data transfer from the network and not the device itself, based on signals received from the devices. The device 100 then send a command to the network to transfer the data however the device presents the virtual physical representation or simulation of the data transfer.

The data may also be portioned as a direct result of the extent of the contextual characteristics of the device 100. If the device is too cold to carry out a certain function, the management of the device may be terminated or suspended in one exemplary embodiment. Another example of a contextual characteristic is a throwing motion. For example the first device 100 is used to gesture a throwing motion to “throw” the information to a second device 102. In yet another example, pulling a physical “trigger” would launch a virtual “projectile” presented on the display 116, representing the transfer of data.

When data is transferred from one device to another, such as music as discussed above, the content may be protected having digital rights associated therewith. Digital rights management (DRM) therefore must be taken into consideration when the data is transferred to another device. In the data pouring example discussed above, the data is transmitted to the second device. In order to comply with the rights of the content owner and the corresponding property, digital rights management must take place as part of the transfer to the second device. In one exemplary embodiment, a DRM agent on the first device 100 is used to determine the rights associated with the content that is to be transferred. Since transferability is a right that is controlled or managed by the DRM agent, the content must have the right to be transferred to another device. Once the DRM agent determines that the content may be transferred, the content may be transferred to the second device. Other rights, or restriction, may also be associated with the content and must also be satisfied before the transfer may occur however the transferability is used for exemplary purposes. As one skilled in the art will appreciate, there are many rights associated with content that may be implemented and therefore must be satisfied prior to any operation involving the content.

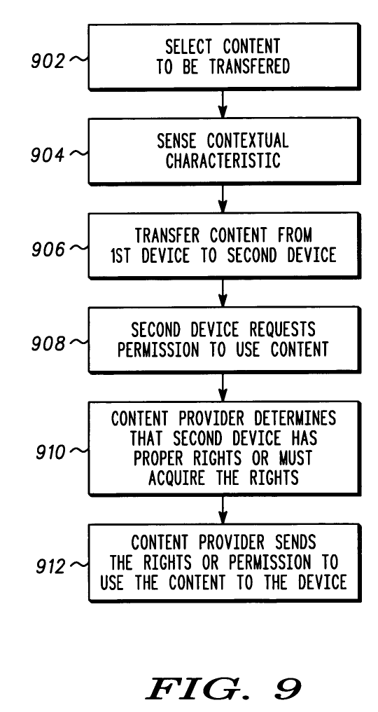

FIG. 9 is an exemplary flow diagram of a data transfer method, wherein the content 104 has digital rights associated therewith. In this exemplary embodiment, the DRM agent, is an entity stored in and executed by the device 100. As discussed, the DRM agent manages the permissions associated with the content which are stored in a rights object. For example, the DRM agent in the exemplary embodiment allows the first device 102 to transfer, directly or indirectly, the content to another device, the second device 102 in this exemplary embodiment. Management of the content must comply with the rights stored in the rights object associated with the content in this embodiment. The rights object and the DRM agents together control how the content is managed. In this exemplary embodiment the DRM agent must be present on the device in order for the content to be accessible.

In this exemplary embodiment, the second device 102 must receive the rights object, i.e. the appropriate rights, or permissions, to the content before the content can be transferred to or used by the second device 102. First, the content to be transferred is selected 902. The contextual characteristic is then sensed 904 by the context sensor or sensors the first device 100. The content is then transferred 906 to the second device 102 along with a content provider identification. The second device 102 requests 908 from the content provider permission to use the content. The content provider determines 910 that the second device has the proper rights or must acquire the rights to use the content. The content provider then sends 912 the rights or permission to use the content to the second device 102. In this embodiment, the second device 102 then uses the content.

In another exemplary embodiment, the content provider 110, or the rights issuer portion thereof, sends the rights object to the second device 102 which in conjunction with the DRM agent presents an option to purchase the rights to use the content. The second device 102, or the user of the second device 102 may send a response accepting or denying the purchase. If the second device 102 accepts, the content provider sends the content. In an alternative exemplary embodiment, the content is already present on the second device 102, the content provider will send only the rights object of the content to the second device 102. In addition, the content rights of the sender may also be modified in this process wherein the sender of the content may forfeit to the receiving device both the content and the rights.

In one exemplary embodiment, certain types of content are predetermined to be only handled by certain gestures. For example, music content may be set up to only be transferred in response to a pouring gesture. Additionally, in this exemplary embodiment, the song playing is the content to be transferred. While playing the song, the pouring gesture is sensed which automatically triggers the transfer of the playing song to a second device. The second device may be a device in close proximity to the first device or chosen from a predetermined list. The source from which the content is transferred from may depend on the characteristics of the content. The source may also depend on the operations of the service provider serving the device which is receiving or sending the content. For example, if the content is a large data file, then it may be more efficient and faster to transfer the content from a source other than the first device 100 which has greater bandwidth and processing power, such as the content provider or the like. If the content is a relatively small set of information, such as a ring tone, contact information or an icon for example, then the content may be transferred directly from the first device 100 to the second device 102. Larger files, such as media and multimedia files including audio, music and motion pictures may be transferred from the content provider.

When the operation requires the transfer of data from one device to another, such as the pouring of data as discussed above, a data path must established. The data may be transferred directly from the first device 100 to the second device 102 or though an intermediary such as a base station commonly used in cellular radiotelephone communication systems or other nodes such as a repeater or an internet access point such as an 802.11 (also known as WiFi) or 802.16 (WiMAX). For example, the wireless device may be programmed to communicate on a CDMA, GSM, TDMA, or WCDMA wireless communication system. The wireless device may also transfer the data through both a direct communication link and an indirect communication link.

Data is transferred from the first device 100 to the second device 102 or vice versa. Any method or data transfer protocol of transferring the data may be used. In one embodiment an ad hoc wireless communication link such as Bluetooth for example is used to establish a direct connection between the first device 100 and the second device 102 and subsequently transfer the desired data. In any case, the transfer of the data is initiated by the predetermined sensed environmental characteristic or gesture whether the data is relayed through an independent node or transmitted directly to the second device.

A wireless communication link which is established directly (i.e. point to point) between the two proximate devices to transfer the data in accordance with a plurality of methods and or protocols. In this exemplary embodiment, the connection is established directly between the first device 100 and the second device 102 without the aid of an intermediary network node such as a WLAN access point or the base station 108 or the like.

In one embodiment, the user of the first device 102 selects a group of users desired to receive the data. There are numerous ways to identify a device such as telephone number, electronic serial number (ESN), a mobile identification number (MIN) or the like. The device designated as the recipient may also be designated by touch or close proximity in general.

Devices having the capability to transmit and receive directly to and from one another in this embodiment must either constantly monitor a predetermine channel or set of channels or be assigned a channel or set of channels to monitor for other proximate wireless communication devices. In one exemplary embodiment, a request is transmitted over a single predetermined RF channel or a plurality of predetermined RF channels monitored by similar devices. These similar devices may be devices that normally operate on the same network such as a push-to-talk PLMRS network, a CDMA network, a GSM network, WCDMA network or a WLAN for example. Similar devices need only however have the capability to communicate directly with proximate devices as disclosed in the exemplary embodiments. In addition to the direct communication capability the device may also operate as a CDMA device and therefore may communicate over the direct link to a device that also operates as a GSM device. Once the link is established, the data is transferred between the devices

There are multiple methods of forming ad hoc and or mesh networks known to those of ordinary skill in the art. These include, for example, several draft proposals for ad hoc network protocols including: The Zone Routing Protocol (ZRP) for Ad Hoc Networks, Ad Hoc On Demand Distance Vector (AODV) Routing, The Dynamic Source Routing Protocol for Mobile Ad Hoc Networks, Topology Broadcast based on Reverse-Path Forwarding (TBRPF), Landmark Routing Protocol (LANMAR) for Large Scale Ad Hoc Networks, Fisheye State Routing Protocol (FSR) for Ad Hoc Networks, The Interzone Routing Protocol (IERP) for Ad Hoc Networks, The Intrazone Routing Protocol (IARP) for Ad Hoc Networks, or The Bordercast Resolution Protocol (BRP) for Ad Hoc Networks.

While the present inventions and what is considered presently to be the best modes thereof have been described in a manner that establishes possession thereof by the inventors and that enables those of ordinary skill in the art to make and use the inventions, it will be understood and appreciated that there are many equivalents to the exemplary embodiments disclosed herein and that myriad modifications and variations may be made thereto without departing from the scope and spirit of the inventions, which are to be limited not by the exemplary embodiments but by the appended claims.

1. A method for sensing the context of an electronic device, the method comprising:
receiving contact information which represents a contact pattern acting on the device;
determining a contextual characteristic associated with the contact pattern;
determining a function operational in response to the contextual characteristic; and executing the function.

2. The method of claim 1, further comprising the step of determining a contextual characteristic of the device in relation to a foreign object in response to receiving the contact information.

3. The method of claim 2, further comprising the step of determining a contextual characteristic of the device in relation to a user.

4. The method of claim 1, wherein the step of receiving contact information further comprises selectively receiving a plurality of signals from a plurality of touch sensors which represent the contact pattern.

5. The method of claim 4, wherein the step of receiving contact information further comprises selectively receiving a signal from a context sensors which senses the proximity of a foreign object.

6. The method of claim 5, wherein the step of determining a contextual characteristic further comprises receiving signals from a context sensor which is any one of an infrared sensor, an ambient light sensor, a camera, a microphone, a radio frequency signal sensor, radio system signal strength detection circuit.

7. The method of claim 6, further comprising the step of executing a function based on the received signal from the context sensor and the contact information.

8. Them method of claim 2, wherein the contextual characteristic is one of a plurality of predetermined configurations in which the device is held by the user.

9. The method of claim 1, executing a first function which corresponds to a first contact pattern and in response the device operating in a first operation mode.

10. The method of claim 9, adjusting a level of a user interface of the device to a first level in response to a first contact pattern and a first operation mode, and
adjusting the speaker to a second level in response to a second contact pattern and the first operation mode.

11. The method of claim 9, activating a first user interface in response to a first contact pattern and a first operation mode, and
deactivating the user interface in response to a second contact pattern and the first operation mode.

12. The method of claim 10, wherein the user interface is one of a display a speaker, haptic feedback device, a microphone, a camera, a keypad, or a touch screen.

13. The method of claim 7, wherein the user interface is one of a display a speaker, haptic feedback device, a microphone, a camera, a keypad, or a touch screen.

14. The method of claim 9, turning on a speaker phone in response to a first contact pattern and a first operation mode, and
turning on an earphone speaker in response to a second contact pattern and the first operation mode.

15. The method of claim 1, further comprising the step of determining a contextual characteristic of the device in relation to a foreign object in response to receiving the contact information.

16. The method of claim 2, further comprising the step of determining a contextual characteristic of the device in relation to a user.

17. The method of claim 1, wherein the step of receiving contact information further comprises selectively receiving a plurality of signals from a plurality of touch sensors which represent the contact pattern.

18. A method for sensing the context of an electronic device, the method comprising:
receiving touch sensor information from at least a subset of touch sensors for a plurality of touch sensors;
determining a contact pattern which corresponds to the subset of touch sensors;
receiving contextual information at the device;
determining the position of the device relative to a foreign object based on the contact pattern;
determining a function operational in response to the position of the device and the and the received contextual information; and
executing the function.

19. The method of claim 18, determining the position of the device relative to a user's body.

20. The method of claim 18, receiving touch sensor information from at least a subset of touch sensors for a plurality of touch sensors that indicate that a user is holding the device in a first gripping configuration.

21. A method in a wireless communication device comprising:
receiving a plurality of input signals from corresponding capacitive touch sensors carried on a housing of the wireless communication device;
determining a touch pattern corresponding to the plurality of input signals received from the capacitive touch sensors;
determining a relative position to a foreign object; and
activating an event in response to receiving the plurality of input signals and the motion input signal.

22. An electronic device comprising:
a housing;
a microprocessor;
a plurality of touch sensors carried on the housing an activatable from the exterior of the housing, wherein the location of each touch sensor of the plurality of touch sensors is configured to determine the poison of foreign objects relative to the housing; and
a context sensor module coupled to the microprocessor and receiving input from the plurality of touch sensors.

23. The device of claim 22, wherein a first touch sensor is on a first side of the device.

24. The device of claim 23, wherein a second touch sensor is carried on a second side of the housing.

25. The device of claim 24, wherein the first side is a left, right, top, bottom, from or back side of the device, and wherein the second side is a left, right, top bottom, from or back side of the device.

26. The device of claim 25, wherein the touch sensor is a capacitive touch sensor.
